(19) United States
(12) Patent Application Publication
(10) Pub. No.: US 2022/0332279 A1
(43) Pub. Date: Oct. 20, 2022

(54) CHILD LAP RESTRAINT WITH ADJUSTABLE TETHER FOR AIDING PROPER SEATING ON COUCHES

(71) Applicant: Uchenna Romaine, Atlanta, GA (US)

(72) Inventor: Uchenna Romaine, Atlanta, GA (US)

(21) Appl. No.: 17/715,740

(22) Filed: Apr. 7, 2022

Related U.S. Application Data
(60) Provisional application No. 63/175,355, filed on Apr. 15, 2021.

(51) Int. Cl. B60R 22/14; B60R 22/26; B60R 22/10

(52) U.S. Cl. CPC B60R 22/14; B60R 22/26; B60R 22/105

(57) ABSTRACT

A lap restraint comprising a lap cushion, a loop fixed to the lap cushion, a rear anchor, a loop fixed to the rear anchor, an adjustable clip, and a tether. One end of the tether is fixed to the lap cushion, and the tether extends through the loop disposed on the rear anchor, the loop disposed on the lap cushion, and the adjustable clip. The lap cushion is configured to engage a person's lap when sitting and the anchor secures the lap restraint in place.

### CROSS-REFERENCE TO RELATED APPLICATION

This application claims the benefit of U.S. Provisional Patent Application Ser. No. 63/175,355 filed Apr. 15, 2021, titled “Child Lap Restraint with Adjustable Tether for Aiding Proper Seating on Couches,” and the subject matter thereof is incorporated herein by reference thereto.

### TECHNICAL FIELD

The present invention relates to a child restraint, and more specifically to a child lap restraint with adjustable tether for use on couches.

### BACKGROUND ART

Child restraint devices are abundant in the prior art when it comes to restraints for the car. The main purpose of these is to keep the child safe in the event of an accident. However, there is a lack of restraint devices for the home, specifically, restraints for use on couches and other home seating areas. When a child, particularly a young child, is seated on a couch, it is desirable to secure the child to the couch in order to prevent them from falling or getting up themselves and to provide a comfortable aid for a child to sit properly.

Therefore, there is a need for a restraint that can be used at home on couches and other sitting areas that allows the child to be secured to the couch and provides a comfortable and safe restraint. The present invention provides a child lap restraint with adjustable tether for aiding proper and secure seating on couches or other seating surfaces.

Certain embodiments of the invention have other steps or elements in addition to or in place of those mentioned above. The steps or element will become apparent to those skilled in the art from a reading of the following detailed description when taken with reference to the accompanying figures.

None of the prior art fully addresses the problems resolved by the present invention. The present invention overcomes these limitations contained in the prior art by providing a child restraint apparatus for children that is sturdy, reliable, easy to use, safe, and inexpensive.

### BRIEF DESCRIPTION OF THE DRAWINGS

FIG. 1 illustrates a top down view of the lap restraint apparatus of the present invention;

FIG. 2 illustrates the lap restraint apparatus of the present invention being worn by a child on a couch;

FIG. 3 illustrates the lap restraint apparatus of the present invention disposed in a couch; and

FIG. 4 illustrates a top down view of an alternate embodiment of the lap restraint apparatus of the present invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures. The term “on” means that there is direct contact among elements.

The present invention provides a child lap restraint with adjustable tether for aiding proper and secure seating on couches or other seating surfaces.

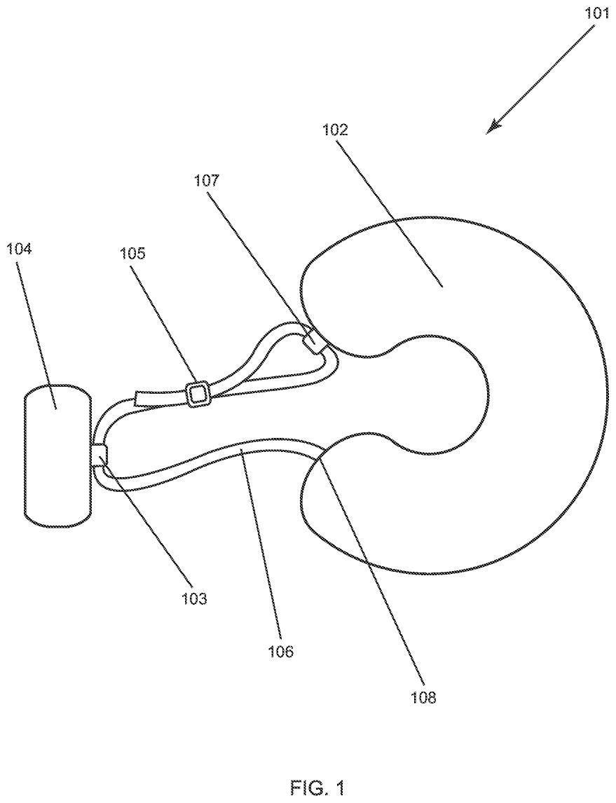

FIG. 1 illustrates a top down view of lap restraint 101. Front loop 107 and tether connection point 108 are disposed on lap cushion 102. Rear loop 103 is disposed on rear anchor 104. One end of tether 106 is securably attached to lap cushion 102 at tether connection point 108, and tether 106 continues through rear loop 103, front loop 107, and adjustable clip 105. Tether 106 terminates thereafter.

Adjustable clip 105 is a prior art component, typically known as a tri-glide slide, and also sometimes referred to as a webbing slide. Adjustable clip 105 comprises a piece of hardware, typically in a rectangular shape, with a bar in the middle, creating two separate openings. Tether 106 is inserted through one opening and out the other opening, thus being in direct contact with the bar in the middle. Adjustable clip 105 securably holds tether 106 and does not allow tether 106 to move except when the user desires. This is accomplished by the user sliding the adjustable clip 105 along tether 106.

Adjustable clip 105 allows for the length of tether 106 to be adjusted easily accordingly as desired due to the thickness of the couch cushions, placement of the child, size of the child, etc. Rear loop 103 and front loop 107 are open loops that allow the distance between lap cushion 102 and rear anchor 104 to be changed by shortening or lengthening tether 106 and locking the length in place at adjustable clip 105.

Lap cushion 102 may comprise any shape such that it securely fits around or partially around a child's lap. Different sizes of lap cushion 102 may be available depending on the size of the child.

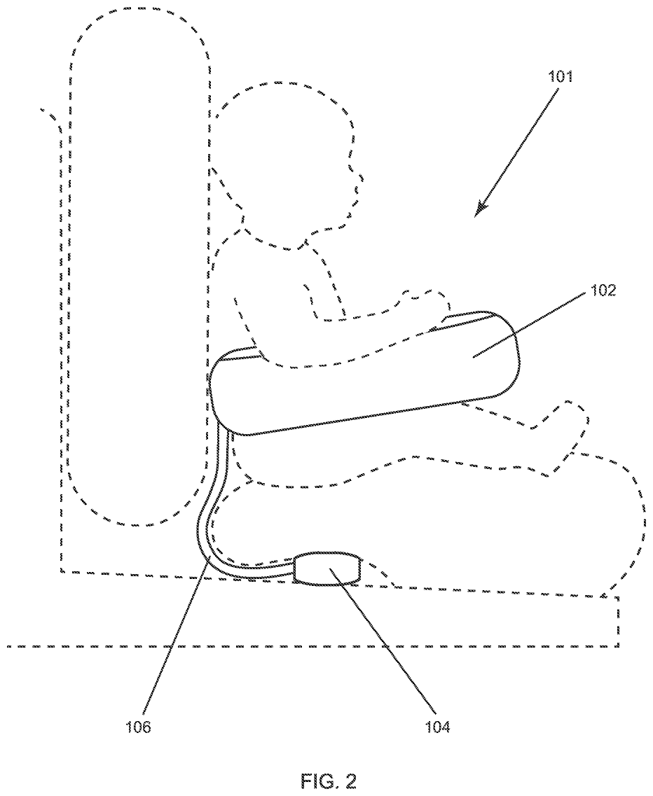

FIG. 2 illustrates lap restraint 101 being worn by a child on a couch. Tether 106 is shown extending in between the couch cushions. Lap cushion 102 is placed around the child's waist and rests on their lap. Lap cushion 102 additionally provides a comfortable place to rest the child's arms on, much like the ends of a couch. In this orientation, rear anchor 104 is placed under the cushion that the child is sitting on. The weight of the child further aids in keeping the child and lap restraint 101 securely in place.

Lap restraint 101 provides a secure, safe, and comfortable restraint for the child.

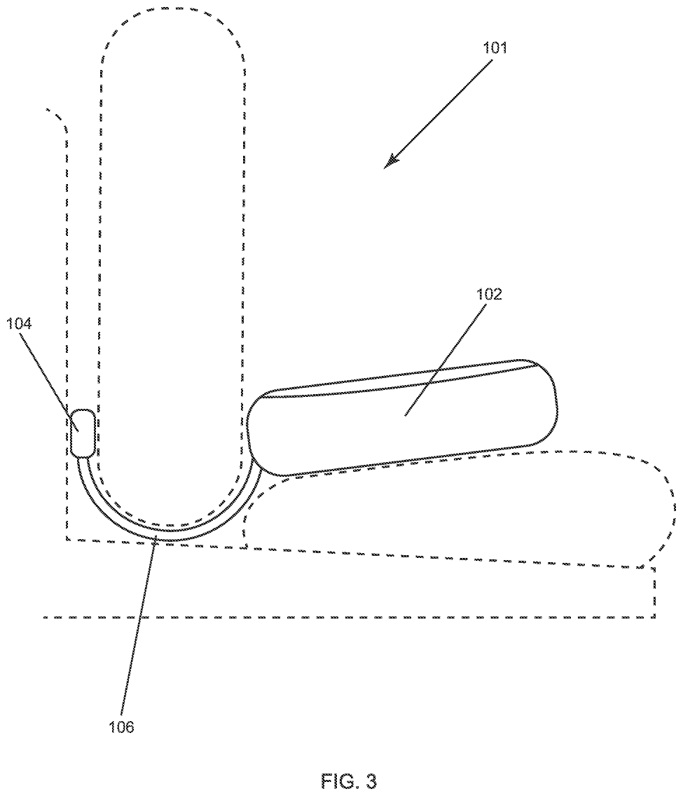

FIG. 3 illustrates lap restraint 101 disposed in a couch. Tether 106 is placed in between couch cushions, and rear anchor 104 holds lap restraint 101 in place. In this orientation, rear anchor 104 is placed behind the cushion.

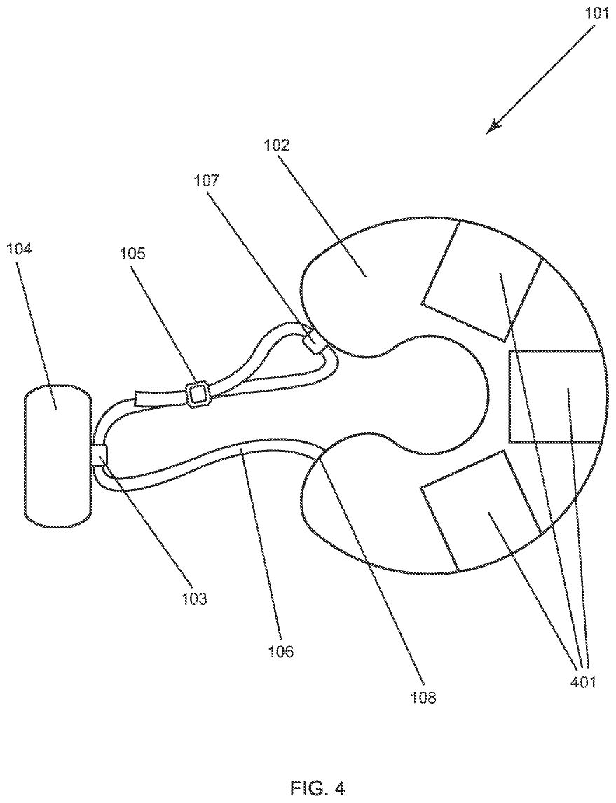

FIG. 4 illustrates a top down view of an alternate embodiment of the lap restraint 101. Attachments 401 allow for items to be attached to lap restraint 101, such as cup holders, toys, etc. Attachments 401 may comprises any type of attachment or fastener points, including but not limited to buttons, clasps, ties, hook and eyes, magnets, toggles, etc.

Rear anchor 104 can be placed in any number of places for use on any number of seats, so long as rear anchor 104 can be anchored properly to hold lap restraint 101 in place. FIG. 3 shows tether 106 inserted between bottom cushion and rear cushion of couch, with rear anchor 104 secured behind rear couch cushion. Tether 106 may also be inserted between rear cushions. Rear anchor 104 may be turned as desired.

Lap cushion 102 may comprise any material, but preferably comprises a soft material, while rear anchor 104 preferably comprises a rigid material.

Rear anchor 104 may comprise any shape, material, and/or size as desired.

Tether 106 may comprise any type of tether, including, but not limited to, strap, rope, cord, etc., which may comprise any material.

Adjustable clip 105 may comprise any means for securing tether 106 and allowing for tether 106 to be adjusted, such as, including, but not limited to, a buckle clasp, a buckled side release buckle, etc. Adjustable clip 105 may be disposed at any location on tether 106.

Tether 106 can be slid out of adjustable clip 105, and then tether 106 can be wrapped around items, such as slats of a chair. This would allow rear anchor 104 to be placed on the other side of the slats of a chair, and then tether 106 is reattached to adjustable clip 105, thus securing lap restraint 101 to the chair. This method can be employed for many types of seating that do not have cushions, thus allowing lap restraint 101 to be used on a large number of seats/chairs.

Lap restraint 101 may be disposed on other seating surfaces. In an alternate embodiment of the present invention, rear anchor 104 may comprise a hook or any other device that securably attaches to seats, such as chairs, sofas, recliners, etc.

Rear anchor 104 may comprise any device that provides attachment to a seating device or otherwise.

In an alternate embodiment of the present invention, lap restraint 101 may comprise any number of rear anchors.

In an alternate embodiment of the present invention, lap restraint 101 may comprise any number, and/or any type, of anchors.

In an alternate embodiment of the present invention, lap restraint 101 may comprise any number, and/or any type, of tethers.

In an alternate embodiment of the present invention, lap restraint 101 may comprise any number of lap cushions.

In an alternate embodiment of the present invention, lap restraint 101 comprises one piece containing lap cushion, rear anchor, and tether. In this embodiment, the pieces are all securably attached and one piece.

It is noted that while a “child” has been referenced throughout, lap restraint 101 is not to be limited for use with only children, but to any humans, or even animals, that need to be securably attached to a seating surface.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A lap restraint comprising:
a lap cushion;
a loop fixed to the lap cushion;
a rear anchor;
a loop fixed to the rear anchor;
an adjustable clip; and
a tether.

2. The lap restraint of claim 1 wherein one end of the tether is fixed to the lap cushion.

3. The lap restraint in claim 2 wherein the tether extends through the loop disposed on the rear anchor and the loop disposed on the lap cushion.

4. The lap restraint in claim 3 wherein the tether extends through an adjustable clip.

5. The lap restraint in claim 1 wherein the adjustable clip is a buckle.

6. The lap restraint in claim 1 wherein the rear anchor is a hook.

7. The lap restraint of claim 1 wherein attachment points are disposed on the lap cushion.

8. The lap restraint of claim 1 wherein the lap cushion is configured to engage a person's lap when sitting.

9. A lap restraint comprising:
a lap cushion;
a loop fixed to the lap cushion;
a rear anchor;
a loop fixed to the rear anchor;
a second rear anchor;
a loop fixed to the second rear anchor;
an adjustable clip; and
a tether.

10. The lap restraint of claim 9 wherein one end of the tether is fixed to the lap cushion.

11. The lap restraint in claim 10 wherein the tether extends through the loop disposed on the rear anchor, the loop disposed on the second rear anchor, and the loop disposed on the lap cushion.

12. The lap restraint in claim 11 wherein the tether extends through an adjustable clip.

13. A lap restraint comprising:
a lap cushion;
two loops fixed to the lap cushion;
a rear anchor;
a loop fixed to the rear anchor;
an adjustable clip; and
a tether.

14. The lap restraint in claim 13 wherein the tether extends through the loop disposed on the rear anchor and the two loops disposed on the lap cushion.

15. The lap restraint in claim 14 wherein the tether extends through an adjustable clip.

16. The lap restraint in claim 13 wherein the adjustable clip is a buckle.

17. The lap restraint in claim 13 wherein the rear anchor is a hook.

18. The lap restraint of claim 13 wherein the lap cushion is configured to engage a person's lap when sitting.
